(19) United States
(12) Patent Application Publication
(10) Pub. No.: US 2001/0054100 A1
(43) Pub. Date: Dec. 20, 2001

(54) Windows Desktop monitoring system

(76) Inventors: Vince Roche, Rock Hill, SC (US); Anthony Troskoski, Rock Hill, SC (US)

Correspondence Address: DOUGHERTY & CLEMENTS LLP, Suite 400, 6230 Fairview Road, Charlotte, NC, 28210, US

(21) Appl. No.: 09/844,777

(22) Filed: Apr. 27, 2001

Related U.S. Application Data
(60) Provisional application No. 60/199,973, filed on Apr. 27, 2000.

(51) Int. Cl. G06F 15/173; G09G 5/00

(52) U.S. Cl. 709/224; 345/736

(57) ABSTRACT

The invention consists of a computer program that operates in a workgroup environment in which a manager is responsible for the activities of employees each of whom have interconnected computer systems. The computer program creates an image of every employee's Windows® 95, 98, NT or 2000 computer screen at selectable intervals and allows retrieval of these images at a later time on another computer in the networked workgroup. In a primitive case, the computer program allows retrieval of these images at a later time on the employee's computer by a manager or other authorized person.

### CROSS REFERENCE TO RELATED APPLICATION

This application claims the benefit of U.S. Provisional Application No. 60/199,973, filed Apr. 27, 2000.

### FIELD OF THE INVENTION

The present invention relates to a system and method for detecting inappropriate computer usage at a workplace, and more particularly for detecting inappropriate Internet usage by selectively capturing samples of employee “soft desktops” for review by a manager.

### BACKGROUND OF THE INVENTION

Providing Internet access at employee computer workstations is an increasingly popular and common event and, at times, a necessity to allow employees to carry out their responsibilities. Unfortunately, a vast number of person-hours are wasted daily by employees using the computer workstation to access the Internet in order to surf the web, play computer games, or engaging in other nonproductive/personal tasks. Lost productivity from such inappropriate Internet usage is costly to individual companies, and as an aggregate, cost businesses billions of dollars annually. Additionally, certain types of inappropriate Internet usage may violate a company's sexual harassment policy. Accordingly, a company needs to detect and remedy such usage to avoid liability.

A conventional methods of tracking an employee's computer activity involves visual monitoring by the manager such as “looking over the employee's shoulder.” This method is extremely time consuming and impractical to monitor: an employee several times per hour, several employees, or an employee at a remote location. Moreover, a manager's constant “viewing over the shoulder” is typically perceived by the employee as distrust and as a trespass into their work area. Consequently, resentment can quickly build. Furthermore, an employee who is viewing an inappropriate Internet site can avoid detection with a quick click of a computer mouse to close or mask the site.

With the ability to access vast sources of information, surfing the web can have a business purpose or an entertainment purpose. To eliminate surfing completely would be unproductive and could prevent an employee from working effectively. No known software application provides the ability to monitor and enforce “responsible” computer usage by selectively capturing samples of employee soft desktops.

What is needed is a system and method to enforce responsible computer usage at the workplace. In particular, what is needed is a system and method to enforce responsible computer usage by selectively capturing samples of employee “soft desktops” while the employee is on the Internet. Furthermore, the system and method need to be time efficient and not detectable by the employee.

### SUMMARY OF THE INVENTION

The invention includes a computer software program that operates in a networked workgroup comprised of interconnected personal computer used by employees. The software allows an authorized person, such as a manager, to view Internet usage of each employee in order to determine whether inappropriate Internet sites were visited. The computer program tracks the employees' Internet usage by creating an image or electronic data file of every employee's Windows®95, 98, NT or 2000 computer screen at selectable intervals and allows retrieval of these images at a later time on another computer in the networked workgroup. In a primitive case, the computer program allows retrieval of these images at a later time on an employee's computer by the authorized person.

### OBJECT OF THE INVENTION

In the broadest sense, an object of the present invention is to provide a method of monitoring computer activity on at least one computer in a network of computers. Each computer is equipt with a display, an input device such as a mouse, and has access to the Internet. The method is performed by selecting a computer in the network for monitoring during periods of time when the computer is in the Internet. Monitoring is performed by periodically and automatically sampling an image presented on the display of the computer. The sampled image is stored in a database. For review of the sampled image, the image is retrieved from the database and displayed.

Another objected of present invention is to select a time period during which an image was sampled, then displaying the sampled image.

Still another object of the present invention is to color code the time period to indicate whether an sampled image was stored, or there is no sampled image stored, for the time period.

In the broadest sense, a method of the present invention includes monitoring computer activity on at least one computer in a network of computers. Each computer is equipt with a display, an input device and access to the Internet. The method includes the steps of displaying a list of computers which can be monitored, displaying a sampling rate field from which a sampling rate per unit of time can be selected, and displaying a list of days. The computer to be monitored is selected from the list of computers. A sampling rate is also selected and the sampled images are stored to a database. The sampling only occurs when the computer is on the Internet. A day and an hour is selected from which the sampled image corresponding to the selected day and hour is retrieved from the database. The retrieved sampled image is deleted from the database after a predetermined time period.

Another object of the present invention is to display a list of minutes which correspond to the selected hour. Each minute is color coded a first or a second color code to indicate whether a sampled image exist for that minute. A third color code is applied when there has been no input from the input device during the minute.

In the broadest sense, a method of the present invention includes monitoring computer activity on at least one computer in a network of computers. Each computer is equipt with a display, an input device and access to the Internet. The method includes the step of displaying a first screen display which has a list of computers which can be monitored and a sampling rate field. A second screen is also displayed which includes a list of days color coded a first color code if there is no sampled image stored in the database and a second color code if there is a sampled image stored in the database. Similarly, a list of hours is displayed which includes a list of hours color coded the first color code if there is no sampled image stored in the database and the second color code if there is a sampled image stored in the database. Further, third screen display shows at least one of the sampled images.

### BRIEF DESCRIPTION OF THE DRAWINGS

The foregoing and other objects will become more readily apparent by referring to the following detailed description and the appended drawings in which:

FIG. 1 shows a local area network (LAN) in a star configuration according to prior art;

FIG. 2 shows a wide area network (WAN) according to prior art;

FIG. 3 shows a set up screen according to this invention;

FIG. 4 shows a time line output screen according to this invention; and

FIG. 5 shows a thumbnail output screen according to this invention.

### DETAILED DESCRIPTION

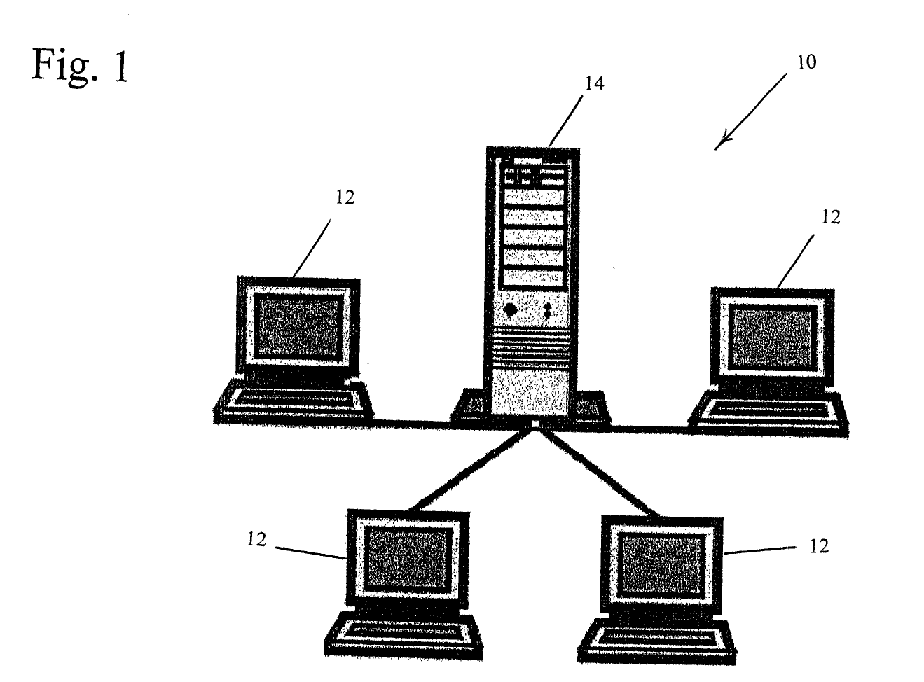

Referring to FIG. 1, a local area network (LAN) 10, is shown in a star configuration according to conventional configuration. The star configuration is one of many typical workgroup organizations. A pre-determined number of PC-workstations 12 are operatively connected to a central controller 14. The central controller 14 relieves the individual PC-workstations 12 from many standard tasks, for example, virus protection. The central controller 14 may be operatively connected to the Internet by a higher speed telecommunication means such as a T1 service. The invented monitoring software system, described in further detail hereinafter, may be called from any computer terminal 12 that is connected to the central controller 14. A password-protected primary user interface allows retrieval of all log entries in the database. The interface may be accessed by clicking on a task-bar icon or by a user defined “hot-key” sequence. Any computer 12 in the networked workgroup may optionally log all entries to the same database. The software program is locally operated or running on each computer 12 to create log entries for that computer 12. Although the software can create log entries, such as sampling images, whenever the computer is on, preferably, the software creates log entries when the computer is on the Internet. By Internet, it is intended to include further advances in the art of the Internet and similar Web-type means.

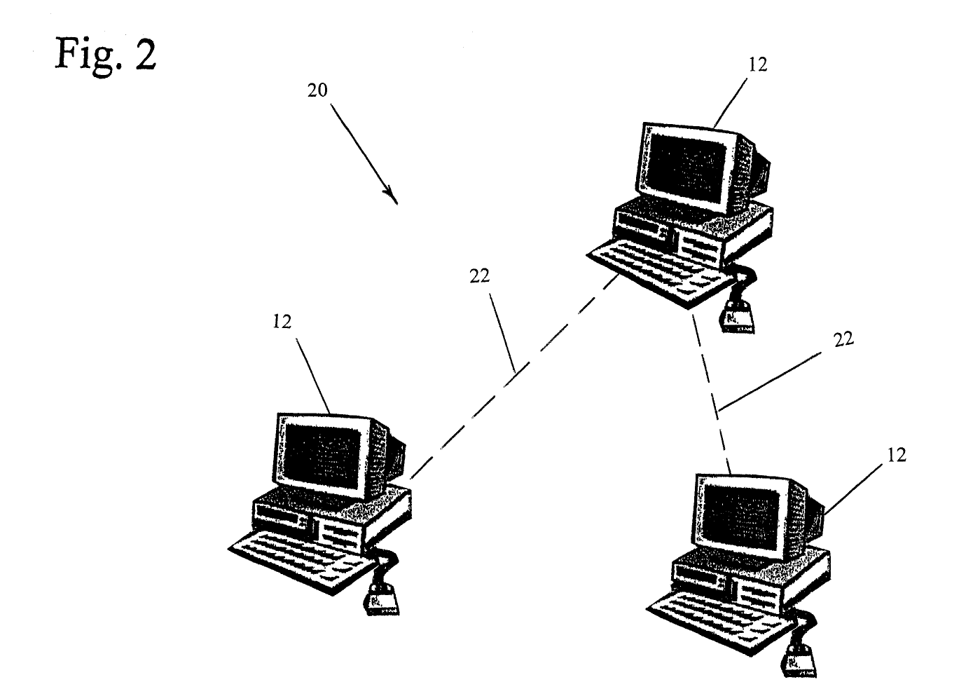

Referring to FIG. 2, a wide area network (WAN) 20 is shown according to prior art. The WAN 20 is another typical workgroup organization and serves a similar function to that of the previously mentioned LAN 10 configuration. However, the PC-workstations 12 are physically remote from one another and interconnected using telecommunication means 22. The invented program may be used on a single computer 12 or virtually any combination of computers 12 on a Local or Wide Area Network 10, 20. The invented program allows manager-defined linking of computer workstations 12 thus creating workgroups for the purpose of monitoring. A workgroup is operationally defined herein as a chosen set of computers viewable by the workgroup manager about which information is compiled. The workgroup manager, using a correct password, may dynamically access all local and remote workgroups.

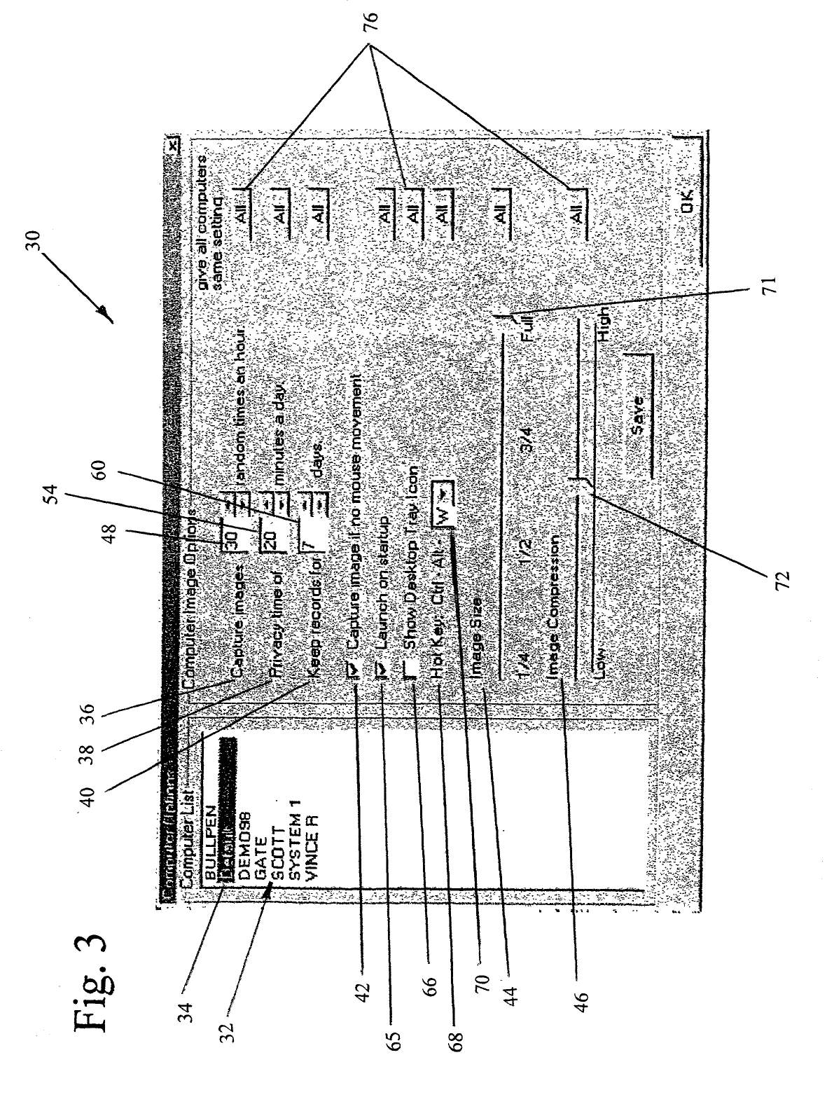

Referring to FIG. 3, the invented software is initialized by the workgroup manager from the illustrated settings screen 30. The settings screen 30 presents an ergonomically satisfactory interface to set up the invented software. On the left is a computer list 32 wherein each computer in the workgroup is named. By computer list 32, it is intended to include any means or method to identify a computer or a person using a computer. For example, the computer list 32 could be a list of employee names wherein the employee would be tracked regardless of which computer in the workgroup the employee used. The manager moves a trailing cursor via a mouse or equivalent pointing means to a desired workstation name 34. The manager then individually selects “Capture images” 36, “Privacy time of” 38, “keep records for” 40, “Capture image for no mouse movement” 42, “Image size” 44, and “Image Compression” 46 settings to create a data set. At “Capture images” 36, the manager may set the number of times per hour 48 that the specific workstation is randomly sampled per hour by “left clicking” an associated [symbol] to increase the count or [symbol] to decrease the count. Alternatively, the “Capture images” 36 can have a field for selecting either linear or random sampling of images per hour.

Where linear sampling is selected, images are captured at a fixed rate such as, for example, ten images/hour. Users of the computer workstations may also be allowed a limited number of privacy minutes. Privacy time is logged by the invented software. At “Privacy time of” 38, the manager may set the number of minutes per day 54 that the specific workstation is permitted, “left clicking” a corresponding [symbol] to increase the count or [symbol] to decrease the count.

To conserve system resources, the data retrieved is automatically erased based on a corresponding time stamp. At “Keep records for” 40, the manager may set the number of days 60 that the data from a specific workstation is retained, “left clicking” a corresponding [symbol] to increase the count or [symbol] to decrease the count.

Minutes containing ‘no mouse movement’ may be flagged at the manager's option. An example of a problematic use of the system where ‘no mouse movement’ is a useful flag or indicator is when an employee might be watching broadcast of entertainment or news on the web. To select this option for a specific workstation, the manager toggles a checkmark to the left of “Capture image if no mouse movement” 42 by “left clicking” the checkmark.

The software may launch automatically or be manually launched by the manager. To select this option, the manager toggles the checkmark to the left of “Launch on startup” 65 by “left clicking” the checkmark.

The password-protected primary user interface allows retrieval of all log entries in the database. The interface may be accessed by clicking on a task-bar icon (not shown) or via a user-defined “hot-key” sequence. To select a “Desktop Tray Icon” option, the manager toggles a checkmark to the left of “Show Desktop Tray Icon” 66 by “left clicking” the checkmark. To define the “hot-key” 68 sequence, the manager rolls the letter to appear in union with Ctrl+alt by “left clicking” the soft-button [symbol] 70.

Sliders [symbol] 71, 72, are used to select the options, “Image Size” 44 and “Image Compression” 46. Both of these options combine to set the storage resources required by each image.

All of the options described hereinabove, may be applied to every workstation in the workgroup set by use of [symbol] 76 soft button that appears to the right of every setting. If this selection is made, the word “All” appears in the button, otherwise the setting applies only to the highlighted work station.

Optionally, the workgroup manager can select several workstations to which the same settings apply. The workstations are selected by using the trailing cursor in conjunction with a shift key. The settings are then selected as described herein above.

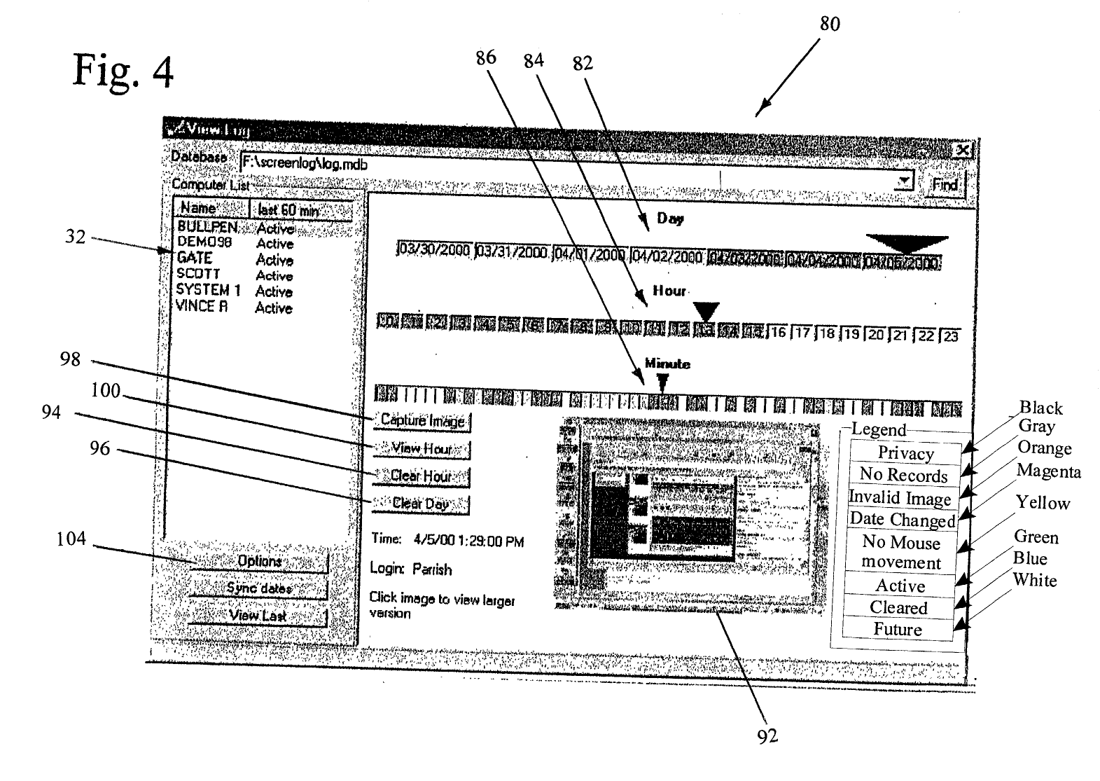

FIG. 4 shows a time line output screen 80 according to this invention. The manager selects a data set that applies to a specific workstation by highlighting the name of the station in the computer list 32 on the left. A soft button Day bar 82 is coded green for each day for which records exist. If there are no records, the Day bar 82 is coded gray. By selecting a green Day bar 82, soft button Hour bars 84 for that day can be selected. Each hour within a selected (green) day is typically coded green if data exists or white if the hour is in the future. By selecting a green Hour bar 84, soft button Minute bars 86 for that hour become available. Each minute within a selected hour is coded according to its state as indicated a Legend 87 in the FIG. 4. For example, if there were no mouse movement during a specific minute, the minute may be coded yellow. By color coded, it is meant to include any manner of distinguishing such as, for example, uses different shapes and different markings.

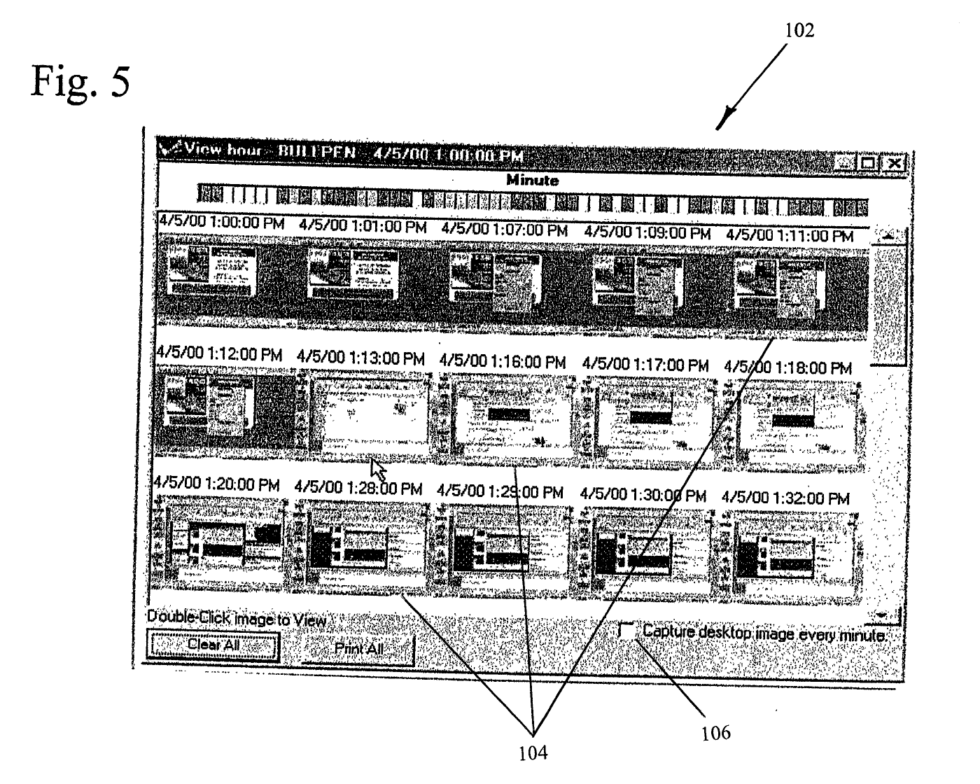

The manager may examine the activity during a selected minute by dragging the pointer to the appropriate day, hour and minute. The hours are sequentially listed from “0” for midnight to 1:00 a.m. through “23” for 11:00 p.m. to midnight. Upon making this selection, an image of the selected workstation desktop is displayed as illustrated by a desktop box 92. By “left clicking” the desktop box image, the image may be enlarged to full size for review. After viewing the desired images for that hour, the manager can use the soft button “Clear Hour” 94 to assure that an “ok” field is not revisited. Selecting the “Clear Hour” 94 button identifies the field as appropriate by turning the Hour bar 84 blue. If the entire day is satisfactory to the reviewing manager, a “Clear Day” soft button 96 may be “left clicked” setting the Day bar 82 and all the Hour and Minute bars 84, 86 blue for that workstation. If an image requires employee explanation, the manager may “left click” “Capture Image” 98 to archive the troublesome image for subsequent joint review and discussion. The manager also has the option of viewing a several captured images at once by “left clicking” a “View Hour,” 100 soft button. This action results in a thumbnail display screen 102 described in further detail hereinafter in FIG. 5.

FIG. 5 shows a thumbnail display screen 102 according to this invention. The thumbnail display screen 102 uses the same color coding described for FIG. 5. The thumbnail display screen 102 has a preselected number of thumbnail desktop box images 104, such as the illustrated fifteen images, from a workstation. Under this option, several sampled images of the employee's desktop are simultaneously viewable.

The thumbnail desktop box images 104 are presented sequentially. That is, the earliest image in time is positioned to the upper left with later images from left to right in descending rows. The number of images presented can be adjusted by selecting the left-clicking the soft button “Options” 104 (FIG. 4), then selecting A “Number of Images” field (not shown) and inserting the number representing preferred number of images per screen. Where the total number of images for a particular hour exceed the number of images setting, a “Next” soft button (not shown) can be left-clicked to present later images for viewing.

The thumbnail display screen 102 allows the manager to target Internet usage and make an assessment of appropriateness. Any image may be “double left clicked” to enlarge the image for closer inspection. If the employee's desktop raises suspicions, the manager may toggle the “Capture desktop every minute” 106 check box to provide a linear time resolution. Alternatively, the “Capture desktop every minute” 106 check box can be provided with a field to insert the desired linear time period in which images are taken.

### SUMMARY OF THE ACHIEVEMENT

### OF THE OBJECTS OF THE INVENTION

From the foregoing, it is readily apparent that we have invented a thorough, robust, password-protected management tool to save random or linearly time related snapshots of a computer's Windows®Desktop, to an image database that includes configuration settings for optimizing an implementation by selecting parameters including the quantity, size and quality of the images thus permitting efficient use of a computer network's resources, including hard disk space. Moreover, the present invention provides this information in a “work group” paradigm where a manager supervises a group of employees resulting in a configuration that allows images from all employees in the workgroup to be captured in a single database and whereby the workgroup's manager has visibility of the desktops of all employees in the workgroup. Moreover, the present invention provides an option whereby a manager can dynamically change his/her visibility to numerous single computers or small workgroups at remote locations. Additionally, the present invention provides reports of basic computer productivity, for example, idle times when no mouse movement occurs.

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. A method of monitoring computer activity on at least one computer in a network of computers, each of said computer having a display, an input device and access to an Internet, said method comprising the steps of:
selecting a computer in said network;
determining when the computer is on the Internet
periodically and automatically sampling an image on said display of said computer when said computer is on said Internet and storing said sampled image to a database;
retrieving said sampled image from said database; and
displaying said sampled image.

2. The method of claim 1 further comprising the steps of selecting a time period in which said sampled image was sampled and displaying said sampled image.

3. The method of claim 2 wherein said time period is an hour.

4. The method of claim 2 wherein said time period is a minute.

5. The method according to claim 2 further comprising the step of selecting a sampling rate of a number of said sampled image stored per unit of time.

6. The method according to claim 5 wherein said sampled image is sampled at random intervals.

7. The method of claim 2 further including the step of displaying said time period, and wherein said time period is color coded a first color code if there is no sampled image stored for said time period and a second color code if there is a sampled image stored for said time period.

8. The method according to claim 7 further comprising the step of simultaneously displaying a plurality of said sampled images, in thumbnail form, retrieved from said database, and wherein said thumbnail said images are enlargable.

9. The method of claim 8 wherein said time period is selectable to be a third color code which indicates that said sampled image during said time period are of an approvable nature.

10. The method according to claim 9 further comprising the step of automatically deleting said stored sampled images after a pre-determined time period.

11. A method of monitoring computer activity on at least one computer in a network of computers, each of said computer having a display, an input device and access to an Internet, said method comprising the steps of:
displaying:
a) a list of computers which can be monitored,
b) a sampling rate field from which a sampling rate per unit of time can be selected in which a sampled image is saved to a database;
c) a list of days, selecting a computer from said list of computers;
selecting a sampling rate per unit of time;
determining when said selected computer is on the Internet;
automatically storing said sampled image to said database according to said sampling rate;
selecting a day from said list of days;
displaying a list of hours corresponding to said selected day;
selecting a hour from said list of hours;
retrieving said sampled image that corresponds to said hour from said database;
displaying said sampled image; and
deleting said sampled image from said database after a predetermined time period.

12. The method of claim 11 further comprising the step of displaying each day in said list of days and each hour in said list of hours in a color code wherein a first color of said color code individually identifies that said sampled image exist for said each day and for said each hour.

13. The method of claim 12 wherein said sampled image is displayed in thumbnail form which are enlargeable.

14. The method of claim 13 further comprising the steps of selecting a maximum number of sampled images that can be simultaneously displayed and selecting said predetermined time period in which said sampled image are deleted from said database.

15. The method of claim 14 further comprising the step of displaying a list of minutes corresponding to said selected hour wherein each minute of said minutes is color coded said first color code when no sampled image for said minute is stored and said second color code when said sampled image is stored for said minute and color coded a third color code when there has been no input from said input device during said minute.

16. A method of monitoring computer activity on at least one computer in a network of computers, each of said computer having a display, an input device and access to an Internet, said method comprising the steps of:
displaying a first screen display having
a) a list of computers which can be monitored, and
b) a sampling rate field;
displaying a second screen having
a) a list of days including a list of individual days color coded a first color code if there is no said sampled image stored in the database and a second color code if there is said sampled image stored in the database per inch corresponding said individual days,
b) a list of hours including a list of individual hours color coded the first color code if there is no said sampled image stored in the database and the second color code if there is said sampled image stored in the database for reach corresponding said individual hours; and
displaying a third screen having
a) at least one of said sampled image.
